(19) United States
(12) Patent Application Publication
(10) Pub. No.: US 2026/0267723 A1
(43) Pub. Date: Sep. 10, 2026

(54) ENHANCED ISSUE STACK ANALYSIS

(71) Applicant: Lemon Inc., Grand Cayman (KY)

(72) Inventors: Mengyu LIU, CULVER CITY, CA (US); Feng ZHU, CULVER CITY, CA (US); Wenbin ZHANG, CULVER CITY, CA (US)

(21) Appl. No.: 19/072,274

(22) Filed: Mar. 6, 2025

(51) Int. Cl. G06F 11/07; G06F 11/22; G06F 11/3668

(52) U.S. Cl. CPC G06F 11/0766; G06F 11/2263; G06F 11/3692

(57) ABSTRACT

The present disclosure involves methods, apparatus, and systems for sending, from a developer portal system and to an issue repository, a request for an issue stack, wherein the issue stack is a report generated in response to a user experiencing a software issue; receiving the issue stack; sending the issue stack and an issue ID to an analysis engine to be analyzed; identifying a bot to analyze the issue stack, wherein the selected bot comprises a first machine learning algorithm; generating a prompt for a generative AI model, the prompt comprising the issue stack; sending the prompt to a generative AI model; receiving a response from the generative AI model; generating an analysis result based on the response from the generative AI model; and sending the analysis result to the developer portal system for presentation at a user interface associated with the developer portal system.

### TECHNICAL FIELD

The present disclosure generally relates to data processing, and in particular, analyzing software issue reports automatically.

### BACKGROUND

Many software environments include automated reporting of failures. These failure reports can occur when software crashes, or some other unexpected issue occurs within the software. In systems where there are many users, large quantities of reports can be generated and need to be assessed or analyzed to improve the software and reduce future issues.

### SUMMARY

The present disclosure relates to a method, system, and computer-readable storage media for automatically parsing and analyzing issue reports in software that runs on multiple devices and across multiple operating systems. The solution can include sending, from a developer portal system and to an issue repository, a request for an issue stack, wherein the issue stack is a report generated in response to a user experiencing a software issue; receiving, from the issue repository and at the developer portal system, the issue stack; sending, by the developer portal system, the issue stack and an issue ID to an analysis engine to be analyzed; identifying, by the analysis engine, a bot to analyze the issue stack, wherein the selected bot comprises a first machine learning algorithm; generating, by the bot, a prompt for a generative AI model, the prompt comprising the issue stack; sending, by the analysis engine, the prompt to a generative AI model; receiving a response from the generative AI model; generating, by the bot, an analysis result based on the response from the generative AI model; and sending the analysis result to the developer portal system for presentation at a user interface associated with the developer portal system.

Implementations can optionally include one or more of the following features.

In some instances, generating the analysis result comprises: performing a search of a knowledge base for information associated with the issue stack; and performing, by the bot, an internet search.

In some instances, the knowledge base comprises previously analyzed issue stacks and corresponding previous analysis results.

In some instances, the first machine learning algorithm is a neural network trained based on the previous analysis results, previously analyzed issue stacks, and manually analyzed issues.

In some instances, generating the analysis result comprises generating a text summary explaining the cause of the software issue.

In some instances, the bot is selected based on an operating system associated with the issue stack.

In some instances, sending the request for the issue stack is triggered in response to a selection of the issue in the user interface associated with the developer portal system.

In some instances, the solution includes: receiving a regeneration command at the analysis engine and in response: re-sending the prompt to the generative model; generating an updated analysis result; and sending the updated analysis result to the developer portal system for presentation.

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

While generally described as computer-implemented software embodied on tangible media that processes and transforms the respective data, some or all of the aspects can be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system for automatically analyzing issue reports.

FIG. 2 illustrates a swim lane diagram showing an example process for analyzing issue reports.

FIG. 3 illustrates an example process user interface that includes an automated analysis of issue reports.

FIG. 4 illustrates an example chart element in the user interface of FIG. 3.

FIG. 5 illustrates an example list element in the user interface of FIG. 3.

FIG. 6 illustrates an example analysis output for an issue displayed in the user interface of FIG. 3.

FIG. 7 is a flowchart illustrating an example process for automated analysis of issue reports.

FIG. 8 illustrates a schematic diagram of an example computing system.

Like reference numbers and designations in the various drawings indicate like elements.

### DETAILED DESCRIPTION

This specification relates to methods, apparatuses, and systems for automatically analyzing issue reports generated when users of a software environment, suite, program, or platform (collectively referred to as a software application) encounter an error such as an unintended mistake, exception, crash, freeze, or issue that occurs during execution development of the software. These issue reports (also referred to as error reports) can be generated by the user device, or in response to the user device indicating an error has occurred. Each issue report can include a “stack” of data that can have a list of functions called by the user device at the time of the error, memory information about the user device (e.g., usage information, installed applications, etc.) and context information associated with the error (e.g., which applications were active, what recent requests were made, etc.). These issue reports can be useful to developers of the software application in resolving software bugs and preventing future crashes or errors as well as improving the security of their software. However, with software executing across multiple platforms, in different operating systems, and with various hardware, a large multitude of possible issue reports can exist. In some implementations, because the issue reports are generated by user devices that executing the software application, the issue reports are not readily available or accessible by the developers of the software application, making it impossible and impractical for the developers of the software application to analyze the issues and provide solutions.

The disclosed techniques provide a systematic approach and platform that can leverage machine learning or artificial intelligence (AI) models to help automate the analysis of the issue reports. The disclosed techniques can prepare proper training data, train AI models including modern generative AI, and use tailored AI models to perform an initial analysis of the issue reports and provide the developers with assistance and guidance on resolving errors identified in the issue reports.

In some implementations, an example system process can be divided into two main parts: issue key information retrieval and automated analysis. For issue key information retrieval, the user can input only the issue ID of the online problem as the query parameter. The system can then retrieve issue information (e.g., crash related information) associated with the issue ID by calling relevant application programming interface (API) interfaces. From the retrieved information, key code stacks and issue types can be extracted to serve as input for further analysis.

For automated analysis, in some implementations, the system inputs the extracted key code stack information and issue type into a generative AI model such as a large language model (e.g., GPT). Based on these inputs, the model automatically searches for the pre-built knowledge base as well as relevant information from the internet, and cross-verifies data to generate issue analysis conclusions and recommended solutions.

In some implementations, the system supports automated storage and sharing of analysis results, which can be output in one or more languages such as both Chinese and English for cross-team use. In some implementations, automated analysis uses the construction and optimization of the knowledge base and the large language model.

For knowledge base construction, the system can collect solved online issue reports, developer documentation, and official guidance documents, and extract key technical points and issue resolution methods. In some implementations, documents are categorized by issue type (e.g., crash type) to build a knowledge base, ensuring the system has abundant reference material for common issues.

For analysis optimization, the system can rely not only on the internal knowledge base but also support searching relevant technical information on the internet. The model can perform cross-verification of these data sources to enhance the accuracy and reliability of analysis results. In some implementations, when generating analysis conclusions, the system can adjust a “Generation Diversity” parameter to ensure innovative yet accurate output. In some implementations, by standardizing the input and output formats, the system supports the standardized storage of analysis results, facilitating subsequent automated analysis and sharing.

As an example implementation, an automated code stack analysis system can include one or more of following components/systems/engines (referred to as modules) that are configured to perform respective functions. Additional or different modules might be included.

Information Extraction Module: configured to extract key code stacks and issue types from issue reports.

Knowledge Base Search Module: configured to search the internal knowledge base for solutions relevant to the crash type.

Internet Information Search Module: configured to search internet resources and retrieve relevant technical information. In some implementations, this module can use a large language model to extract and digest internet search results.

Conclusion Generation Module: configured to generate problem analysis conclusions and solutions based on extracted information and searched resources.

Result Output Module: configured to support the output of analysis results in one or more language such as both Chinese and English and store them in the system.

As an example implementation, the automated analysis method can include one or more of the following steps. Additional or different steps might be included.

Step 1: Retrieve the issue report corresponding to the issue ID;

Step 2: Extract code stack information and issue type from the crash report;

Step 3: Input the extracted information into the large model;

Step 4: Search the knowledge base and internet resources to generate analysis conclusions;

Step 5: Output and store the analysis conclusions (e.g., as an analysis result).

In some implementations, the disclosed techniques can provide knowledge base categorized by issue type. For example, the disclosed techniques can integrate and organize internal documentation for issue resolution with official operations system (e.g., iOS and Android) troubleshooting guides to extract valuable information. In some implementations, the knowledge base is segmented by issue types, creating dedicated resources for each issue category.

In some implementations, the disclosed techniques can extract key issue stack information. For example, the disclosed techniques can extract only the code stack information of the thread where the issue (e.g., crash) occurred, including the method call path, file name, and function name, while filtering out irrelevant stack information.

In some implementations, the disclosed techniques can provide optimization of the analysis algorithm. For example, using the preprocessed information above, the algorithm can highlight key stacks and issue types. Leveraging LLM capabilities, the algorithm can conduct targeted keyword searches across the network and knowledge base to find relevant solutions. In some implementations, by adjusting and optimizing LLM parameters, the accuracy of output results is enhanced. In some implementations, the analysis results are provided in both Chinese and English and are output in a specified format, making them easier to document and retrieve.

These disclosed techniques can provide one or more technical advantages and effects and help address the inefficiencies and limitations in manual issue analysis for online stability problems. For example, the disclosed techniques can achieve increased efficiency in issue resolution. In some implementations, automating the extraction of critical crash information and intelligent analysis reduces the time required to troubleshoot issues significantly. By eliminating the need for manual inspection and repeated log checks, the system enables faster issue diagnosis and resolution, allowing development teams to address multiple issues simultaneously.

In some implementations, the disclosed techniques can achieve enhanced scalability and knowledge sharing. For example, the knowledge base constructed and organized by issue type reduces dependency on individual expertise, as it provides the team with consistent and accessible troubleshooting resources. In some implementations, the system can allow output format in multiple languages, such as Chinese and English, which allow for easy sharing and documentation, ensuring that results are accessible across teams and regions. In some implementations, such a feature enables systematic documentation of insights and solutions, which can be reused in future troubleshooting.

In some implementations, the disclosed techniques can achieve reliable, consistent, and cross-validated analysis. For example, using large language models (LLMs) to process and analyze crash information, the system can provide reliable and consistent analysis across issues. In some implementations, cross-verification between the knowledge base and internet resources improves the accuracy and relevance of proposed solutions, increasing the likelihood of issue resolution on the first attempt.

In some implementations, additional or different technical effects and/or advantages can be achieved.

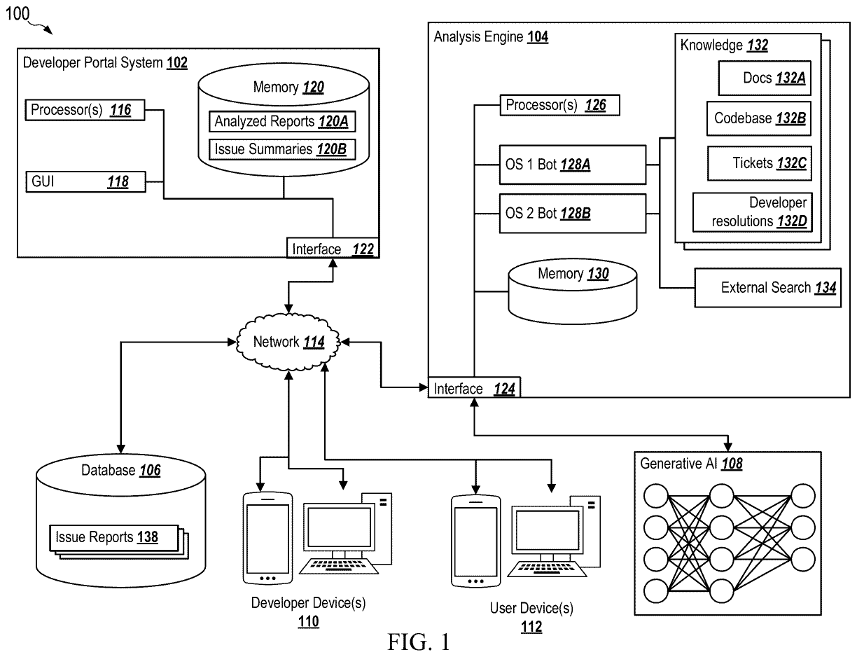

FIG. 1 illustrates a block diagram of an example system 100 for automatically analyzing issue reports. The system 100 includes a developer portal system 102, an analysis engine 104, a database 106, and a generative AI model 108. The system 100 can include or be coupled with additional or different devices or systems. These various components of system 100 can communicate using a network 114 and can be implemented as separate server systems or a single computing system. That is, while illustrated as separate components, one or more elements of system 100 can be contained within a single server or server system; or can be distributed across multiple servers or server systems.

The developer portal system 102 includes, for example, a memory 120, one or more processors 116, a graphical user interface (GUI) 118, and an interface 122. In general, the developer portal system 102 can be accessed by one or more developers using developer devices 110. The developer portal system 102 enables developers, for example, to access issue reports 138 for analysis when updating software, resolving bugs with the software, or introducing new features to the software. Interface 122 is used by the developer portal system 102 to communicate with other systems in a distributed environment—including within the system 100—connected to the network 114 (e.g., developer devices 110, and other systems communicably coupled to the illustrated developer portal system 102 and/or network 114. Generally, the interface 122 includes logic encoded in software and/or hardware in a suitable combination and operable to communicate with the network 114 and other components. More specifically, the interface 112 can include software supporting one or more communication protocols associated with communications such that the network 114 and/or interface's 122 hardware is operable to communicate physical signals within and outside of the illustrated system 100. Still further, the interface 122 can allow the developer portal system 102 to communicate with the analysis engine 104, and in some implementations, database 106, and/or other portions illustrated within the system 100 to perform the operations described herein.

Network 114 facilitates wireless or wireline communications between the components of the system 100 (e.g., between the developer portal system 102, the analysis engine 104, the developer devices 110, etc.), as well as with any other local or remote computers, such as additional mobile devices, clients, servers, or other devices communicably coupled to network 114, including those not illustrated in FIG. 1. In the illustrated environment, the network 114 is depicted as a single network, but can comprise more than one network without departing from the scope of this disclosure, so long as at least a portion of the network 114 can facilitate communications between senders and recipients. In some instances, one or more of the illustrated components (e.g., the analysis engine 106, the database 106, etc.) can be included within or deployed to network 114 or a portion thereof as one or more cloud-based services or operations. The network 114 can be all or a portion of an enterprise or secured network, while in another instance, at least a portion of the network 114 can represent a connection to the Internet. In some instances, a portion of the network 114 can be a virtual private network (VPN). Further, all or a portion of the network 114 can comprise either a wireline or wireless link. Example wireless links can include 802.11a/b/g/n/ac, 802.20, WiMax, LTE, and/or any other appropriate wireless link. In other words, the network 114 encompasses any internal or external network, networks, sub-network, or combination thereof operable to facilitate communications between various computing components inside and outside the illustrated system 100. The network 114 can communicate, for example, Internet Protocol (IP) packets, Frame Relay frames, Asynchronous Transfer Mode (ATM) cells, voice, video, data, and other suitable information between network addresses. The network 110 can also include one or more local area networks (LANs), radio access networks (RANs), metropolitan area networks (MANs), wide area networks (WANs), all or a portion of the Internet, and/or any other communication system or systems at one or more locations.

Each of the one or more processors 116 can be a central processing unit (CPU), an application specific integrated circuit (ASIC), a field-programmable gate array (FPGA), or another suitable component. Generally, the processor 116 executes instructions and manipulates data to perform the operations of the developer portal system 102. Specifically, the processor 116 executes the algorithms and operations described in the illustrated figures, as well as the various software modules and functionality, including the functionality for sending communications to and receiving transmissions from analysis engine 104, as well as to other devices and systems. Each processor 116 can have a single or multiple cores, with each core available to host and execute an individual processing thread. Further, the number of, types of, and particular processors 116 used to execute the operations described herein can be dynamically determined based on a number of requests, interactions, and operations associated with the developer portal system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of 4GL, as well as others.

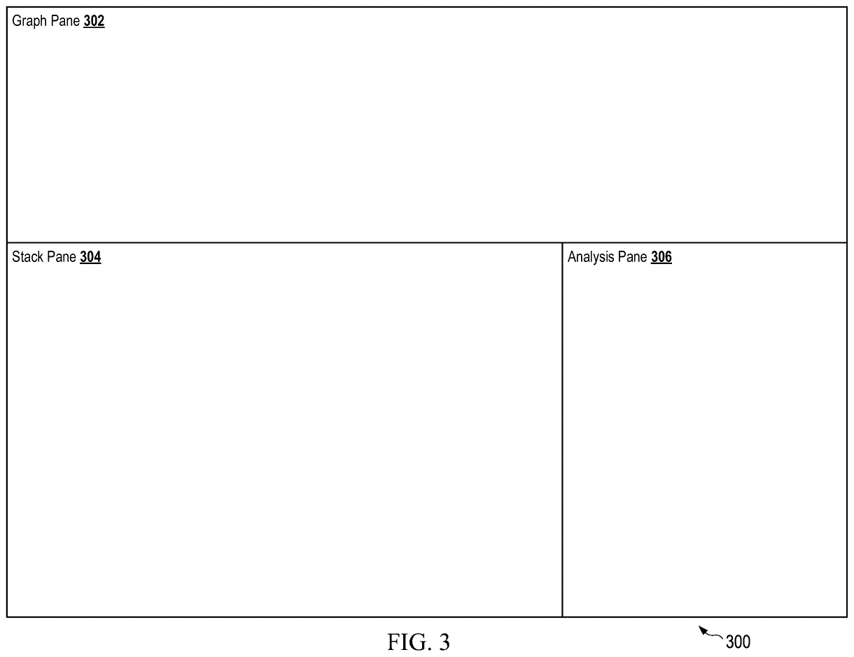

GUI 118 of the developer portal system 102 interfaces with at least a portion of the system 100 for any suitable purpose, including generating a visual representation of any particular application or results and/or the content associated with any components of the developer devices 110. In particular, the GUI 118 can be used to present results of a query or allow the developer to input queries to the developer portal system 102, as well as to otherwise interact and present information associated with one or more applications. GUI 118 can also be used to view and interact with various web pages, applications, and web services located local or external to the developer portal system 102. Generally, the GUI 118 provides the user with an efficient and user-friendly presentation of data provided by or communicated within the system. The GUI 118 can include a plurality of customizable frames or views having interactive fields, pull-down lists, and buttons operated by the user. In general, the GUI 118 is often configurable, supports a combination of tables and graphs (bar, line, pie, status dials, etc.), and is able to build real time portals, application windows, and presentations. Therefore, the GUI 118 contemplates any suitable graphical user interface, such as a combination of a generic web browser, a web-enable application, intelligent engine, and command line interface (CLI) that processes information in the platform and efficiently presents the results to the user visually. An example GUI 118 is illustrated below with respect to FIGS. 3-6.

User devices 112 and developer devices 110 are computing devices or computers used by one or more users and developer of the software application to interact within system 100, respectively. For example, the developer devices 110 can interact with the developer portal system 102 to perform automatic issue report analysis. In some cases, system 100 describes an enterprise computing environment, where the developer devices 110 can analyze database objects (e.g., issue reports 138, analyzed reports 120A, etc.) automatically. As used in the present disclosure, the term “computer” or “computing devices” is intended to encompass any suitable processing device. For example, the developer devices 110 can be any computer or processing device such as, for example, a blade server, general-purpose personal computer (PC), Mac® workstation, UNIX-based workstation, or any other suitable device. In other words, the present disclosure contemplates computers other than general-purpose computers, as well as computers without conventional operating systems. Similarly, the developer devices 110 can be any system that can request data and/or interact with the developer portal system 102. The developer devices 110, in some instances, can be desktop systems, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The developer devices 110 can include one or more specific applications executing on the developer devices 110, or the developer devices 110 can include one or more Web browsers or web applications that can interact with particular applications executing remotely from the developer devices 110.

In some implementations, the user devices 112, while executing software, generate issue reports 138 when an error is encountered. The issue reports 138 can be generated automatically or manually by the user and can be transmitted to database 106 for storage.

In general, when using the developer portal system 102, the developers (using the developer devices 110) can use the issue reports 138 to determine at least what caused the issue, and how it can be prevented in the future. Additionally, developers can assess whether there are inefficiencies or security issues associated with the software based on the issue reports 138. The developer portal system 102 can request issue reports 138 from an external database 106 over the network 114 (where developer portal system 102 is remote from database 106) using interface 122. The issue reports 138 can be retrieved from the database 106, for example, using an application programming interface (API), and can be stored in a separate memory 120 associated with the developer portal system 102. The issue reports 138 can then be sent to the analysis engine 104 for analysis. After analysis, analyzed reports 120A and issue summaries 120B can be stored in memory 120 for future reference, training of machine learning models, or other purposes. Additionally, the issue summaries 120B and analyzed reports 120A can be presented in GUI 118 to assist developers in handling issues. Presentation of the analyzed reports 120A and issue summaries 120B is described in further detail below with respect to FIGS. 3-6.

Memory 120 can represent a single memory or multiple memories. The memory 120 can include any memory or database module and can take the form of volatile or non-volatile memory including, without limitation, magnetic media, optical media, random access memory (RAM), read-only memory (ROM), removable media, or any other suitable local or remote memory component. The memory 120 can store various objects or data, including digital asset data, public keys, user and/or account information, administrative settings, password information, caches, applications, backup data, repositories storing business and/or dynamic information, and any other appropriate information associated with the developer portal system 102, including any parameters, variables, algorithms, instructions, rules, constraints, or references thereto. Additionally, the memory 120 can store any other appropriate data, such as VPN applications, firmware logs and policies, firewall policies, a security or access log, print or other reporting files, as well as others. While illustrated within the system 100, memory 120 or any portion thereof, including some or all of the particular illustrated components, can be located remote from the system 100 in some instances, including as a cloud application or repository or as a separate cloud application or repository when the system 100 itself is a cloud-based system.

The analysis engine 104, as illustrated, includes one or more processors 126 and one or more memories 130, which can be similar to or different from the processor 116 and memory 120 as described above. The analysis engine 104 features one or more bots 128 such as bots 128A and 128B which receive issue reports 138 from the developer portal system 102 and generates analyzed reports 120A and issue summaries 120B.

In some implementations, each bot 128A or 128B can include one or more of a machine learning model such as a neural network, script, programs, or other software to consolidate information related to an issue report 138 from a knowledge base 132, external search 134, and an external generative AI model 108. In general, when an issue report 138 is sent to the bot 128 for analysis, the bot 128 performs a search of the knowledge base 132, which can include documentation 132A (e.g., previous reports, published bug workarounds, security notices, etc.) a codebase 132B which can include known issues, functions, function descriptions, help pages, etc., other support tickets 132C (including completed tickets and outstanding tickets) and past developer resolution 132D. The past developer resolutions 132D can be manually resolved issues, or issues that were previously resolved by the bots and approved by developers. In some implementations, the knowledge base 132 can be categorized based on issue type or another type. In some implementations, dedicated resources for each issue type (e.g., each type of crashes) can be created in the knowledge base 132.

In addition to the knowledge base 132, the bots can perform an external search 134, using for example, internet search engine, or general data scraping to identify information associated with the issue report 138 being analyzed. In some implementations, cross-validation can be performed between the search results based on the knowledge base 132 and the external search 134 to further improve the analysis accuracy and performance.

In some implementations, the bots 128A and 128B can query a trained generative AI 108, which can be external to, or internal to the analysis engine 104 and can include one or more machine learning algorithms and/or neural networks trained to provide detailed summaries and analysis of the retrieved knowledge in a brief, human readable format. In some implementations, the generative AI 108 is a large language model (LLM). In some implementations, the bots 128A and 128B generate a prompt based on their initial query of the knowledge base 132 and external search 134, and send the prompt to the generative AI 108.

Generally, machine learning can include three phases, namely a training phase, a testing phase, and an application phase (also referred to as an inference phase). In the training phase, a given model may be trained by using a large amount of training data, updating parameter values, for example, constantly and iteratively until the model obtains consistent reasoning that meets expected goals from the training data. By training, the model may be considered as being able to learn an association between input and output from training data (also referred to as mappings of input to output). Parameter values of the trained model are determined. In the testing stage, a test input is applied to the trained model, so as to test whether the model can provide a correct output, thereby determining the performance of the model. Sometimes, the testing phase may be fused in the training phase. In the application or inference phase, the trained model may be configured to process actual model input based on the trained parameter value to determine corresponding model output.

The generative AI 108 can include one or more neural networks. A “neural network” can be a deep learning-based machine learning network. The neural network processes inputs and provides respective outputs, which typically include an input layer and an output layer and one or more hidden layers between the input layer and the output layer. Neural networks used in deep learning applications can often include many hidden layers, increasing the depth of the network. Each layer of the neural network can be connected in sequence such that the output of the previous layer is provided as an input to the next layer, where the input layer receives the input of the neural network, and the output of the output layer serves as the final output of the neural network. Each layer of the neural network includes one or more nodes (also referred to as processing nodes or neurons), each node processing input from the previous layer.

The generative AI 108 can be deployed within the analysis engine 104 or may be deployed on other devices. The generative AI 108 may be based on any suitable model structure including, but not limited to, a Transformer model, a convolutional neural network (CNN), a recurrent neural network (RNN), a deep neural network (DNN), or the like. In some implementations, the generative AI 108 may be based on a language model (LLM). In some implementations, the generative AI is a commercially available LLM or another specifically designed or trained generative AI model. In some implementations, the generative AI 108 is pretrained on knowledge base 132, or other resources to respond to the bot 128 in the requested format and with information according to the prompt provided by the bot 128.

In some implementations, each bot 128A and 128B is trained to consume a specific type of issue report 138. For example, bot 128A can handle issue reports generated on ANDROID devices, while bot 128B handles issue reports for IOS devices. It should be noted that more bots 128 or fewer bots 128 is possible. For example, a bot 128 can be trained to consume issue reports for specific function calls, or other operating systems (e.g., Windows) among other things.

The bots 128 can be, for example, a GPT-based system powered by a transformer network. They can be trained using formatted data (e.g., plaintext data and JSON data) representing previously documented online issues and their corresponding solutions. Additionally, documentations such as development notes, and administrative files, readme files, etc. can be provided during training. The trained bots 128 analyze issues by parsing user input to identify key elements of the input (e.g., issue descriptions, potential error codes, and context). Generating contextual follow-up suggestions if further clarification or details are required. And suggesting the most relevant solutions based on their understanding of prior issues and solutions in the training data.

The bots 128 can receive an output from the generative AI 108, and provide an analyzed report 120A and issue summary 120B back to the developer portal system 102 for display in the GUI 118 and storage in memory 120.

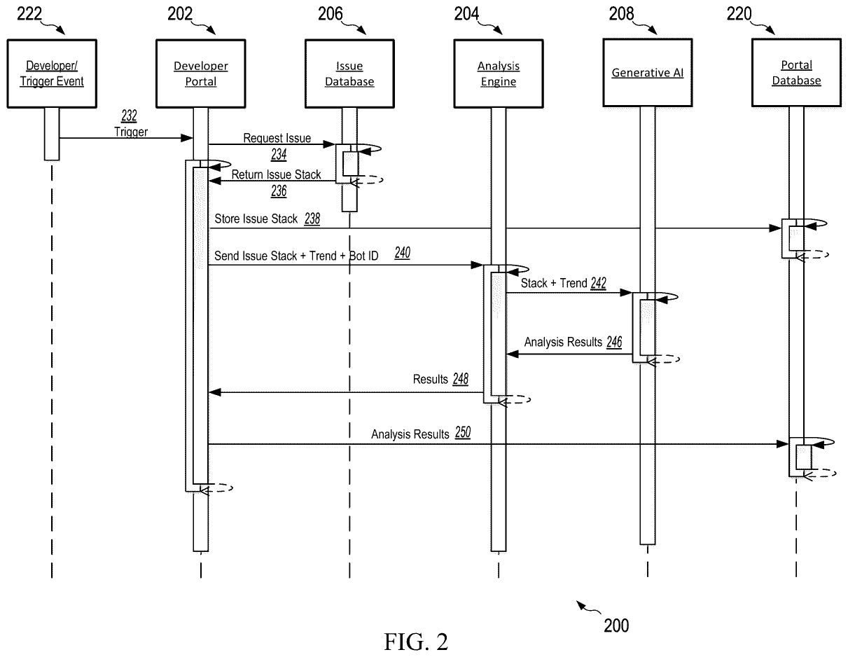

FIG. 2 illustrates a swim lane diagram showing an example process 200 for analyzing issue reports. The example process 200 can be performed by a system including one or more of a developer device 222, an issue database 206, a developer portal 202, a portal database 220. In some implementations, the system can support multiple different software applications and help provide automatic issue analyses for the different software applications. For example, in some implementations, the issue database 206 can store issue reports for all the different software applications, whereas the portal database 220 can store issue reports specific for one of the different software applications. In some implementations, each of the different software applications can have a respective portal database 220, analysis engine 204, and/or generative AI 208 specific to the software application. In some implementations, if only one software application is supported or active, some of the system components (e.g., the issue database 206) and interactions may be optional.

A trigger event or developer query (222) can initiate the process 200, which then can continue automatically, or without human assistance/intervention. The trigger event (232) can be a request from a developer, such as the developer selecting a particular issue or set of issues to be analyzed, for example, by clicking/opening a link. In some implementations the trigger event can be the generation of a new issue report or issue type.

The developer portal 202, which can be similar to, or distinct from the developer portal system 102 of FIG. 1, can request an issue stack (234) from an issue database 206. The issue database can pull the issue stack and return it to the developer portal (236). In general, the issue stack can be a component of an issue report generated upon the encounter of an error or crash in a piece of software. It can include an issue identifier (issue ID) that uniquely identifies the issue. The issue ID can be generated by the issue database 206 when an issue occurs and uploaded (e.g., by the user device) to the issue database 206 for storage. The issue stack can also include a list of function calls active at the time of the error, this can include arguments, expected returns and status. The issue stack can include, for example, one or more of a system context including running software, memory usage information, or hardware data (e.g., processor make/model, operating system, etc.).

The requested issue stack is returned to the developer portal which can store the stack (238) in a portal database 220. The portal database 220 can be local to the developer portal system 202. By storing the issue stack locally, or otherwise in more available storage, it can be readily retrieved for future analysis or training of machine learning models.

The developer portal 202 can then send the issue stack, a bot ID indicating the requested bot for analysis, and trend data (e.g., the number of similar issues, timing of the issue, or frequency of this particular issue) to an analysis engine 204 for analysis (240). The analysis engine 204 can be similar to, or different from analysis engine 104 as described above with reference to FIG. 1. The bot ID can be selected by the developer portal 202 or the analysis engine 204 based on the issue stack. For example, an IOS bot can be selected for issue stacks originating from Apple hardware. In another example, an English bot can be selected for issue stacks originating from English language software versions, a Chinese bot can be selected for issue stacks originating from English language software versions, and so on.

The associated bot analyzes the issue stack by searching and compiling relevant information from a local knowledge base, and in some instances, an external search. This data and the issue stack itself are then provided to a generative AI (242) along with the trend data. The generative AI 208 can be an LLM, neural network, or another AI model that is trained to receive issue stacks as input, analyze issue stacks and provide a summary of the cause, and/or possible solutions for preventing future issues.

Analysis results are returned (246) to the analysis engine 204 from the generative AI 208 which can then generate an analyzed issue stack and send results (248) to the developer portal. In some implementations, the results are presented in a GUI at the developer portal. The analysis result can include one or more of a summary of the cause of the issue, possible solutions, as well as preventative measures. Additionally the analysis result can include plaintext descriptions and information regarding the error, it's frequency, and common resolutions of similar issues. The results in 248 can be the same as or different from the analysis results in step 246, for example, by including additional information such as frequency or timing data besides the analysis results.

The analyzed issue stack can then be sent (250) to the portal database 220 for future reference, use in training, or curation by the developer devices.

FIG. 3 illustrates an example graphical user interface (GUI) 300 that includes an automated analysis result of issue reports. This GUI 300 includes a graph pane 302, a stack pane 304, and an analysis pane 306. It should be noted that, while three panes are illustrated, more or fewer panes are possible. Further, in some implementations, each pane can be reorganized, resized, or otherwise adjusted according to the user's preferences. Each pane may include additional interactive interface elements, such as a scroll bar, or tool icons indicating functions to be performed associated with the respective pane or the GUI 300 in total.

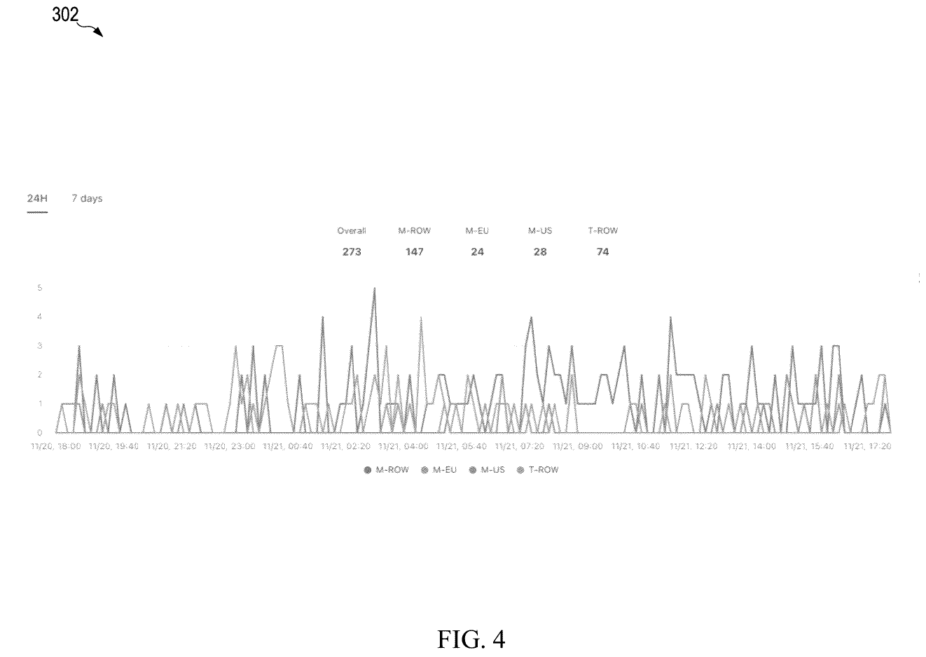

FIG. 4 illustrates an example chart element in the user interface of FIG. 3. This chart element can be presented in the graph pane 302 and includes line graphs that show the frequency of error reports over a specified period of time (e.g., 24 hours in the illustrated example).

In some implementations, error reports are categorized (e.g., by type, operating system, region, server, or other characteristic) and shown in different colors based on the category. In general, the graph pane 302 enables developers to readily assess the overall frequency and severity of different categories of reports in order to prioritize the most urgent ones.

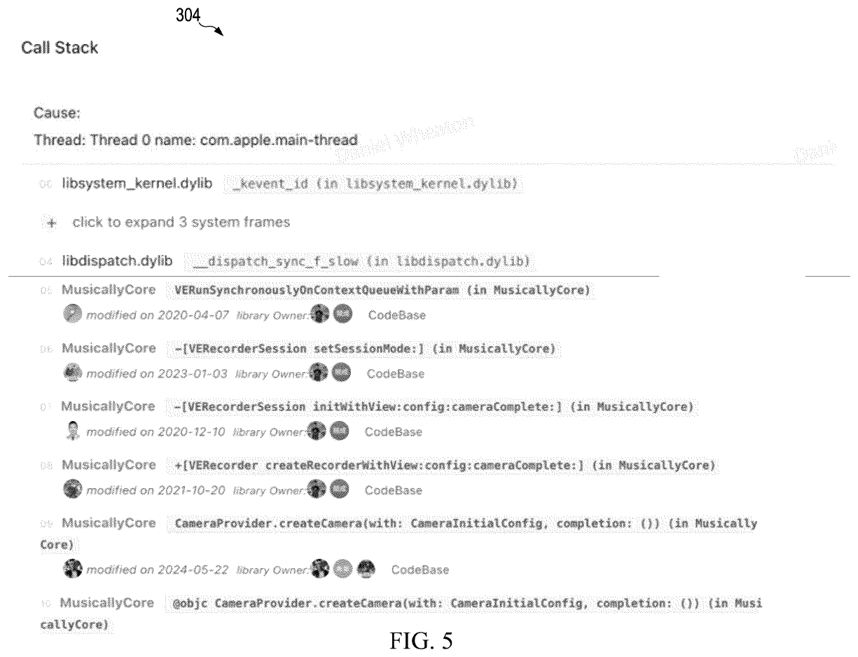

FIG. 5 illustrates an example list element in the user interface of FIG. 3. The stack pane 304 is shown with an example issue stack from an example report. It shows that the thread “MusicallyCore” was executing and several function calls from that thread that were called at the time of the error. In some implementations, when the developer selects a particular issue stack, the issue stack pane 304 is populated, and a local database associated with the analysis engine is searched for an analyzed version of a similar issue to populate the associated analysis pane 306. If no such analyzed issue stack is present, the selected issue stack can be sent to an analysis engine to be analyzed, as described above with respect to FIGS. 1-2.

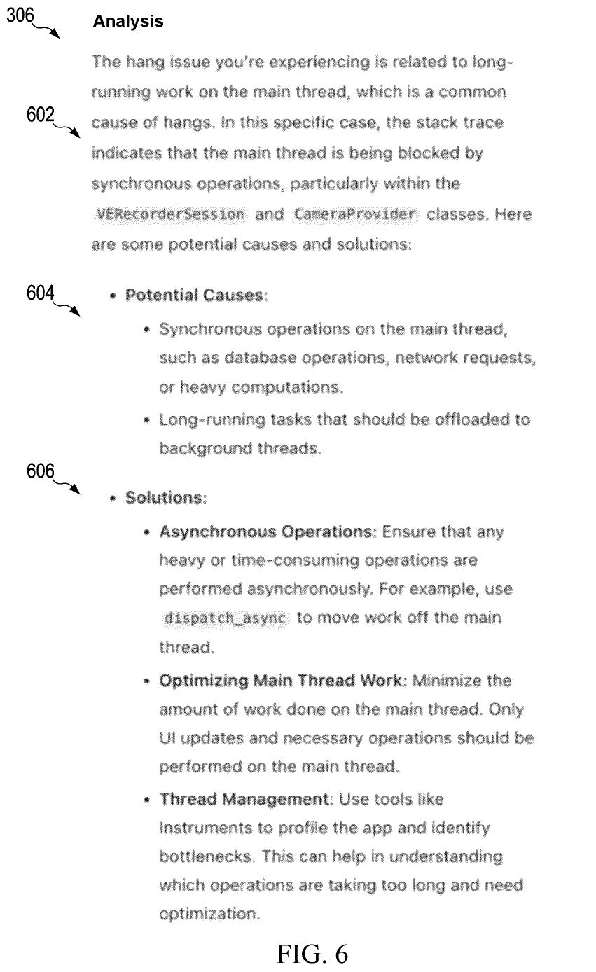

FIG. 6 illustrates an example analysis output for an issue displayed in the user interface of FIG. 3. The analysis output can be displayed in the analysis pane 306 and includes a summary of the issue 602, a list of potential causes 604, and a list of potential solutions 606. In some implementations, this analysis is the result of the analysis as described above with respect to FIGS. 1 and 2. That is, a bot can analyze a knowledge base, prompt a generative AI model, receive a result, and then generate an output similar to the illustrated output.

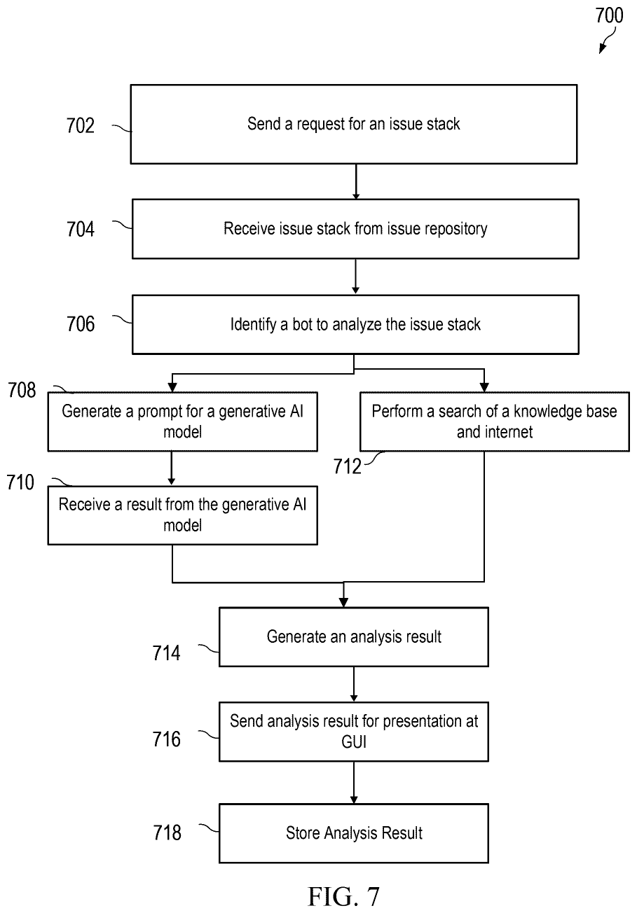

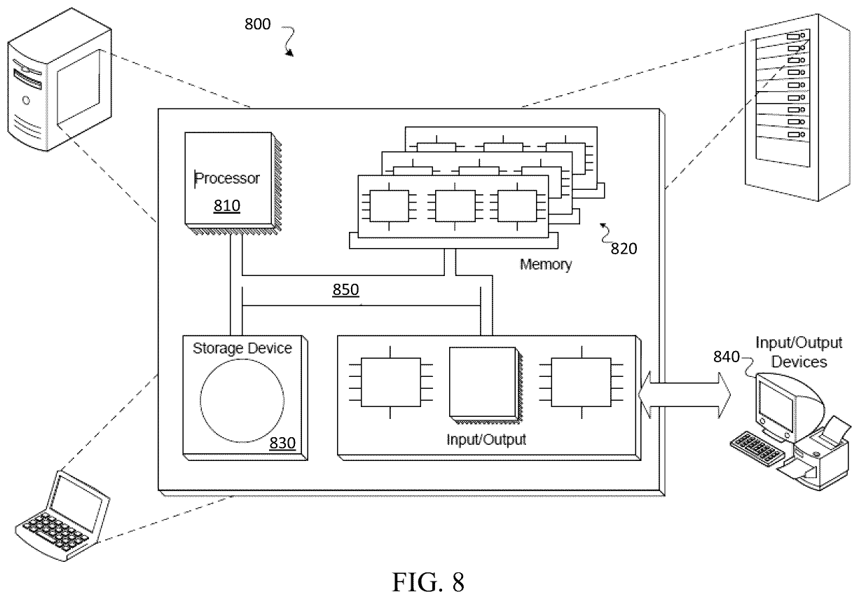

FIG. 7 illustrates a flow chart of the example process 700 of analyzing an issue stack (e.g., as shown by the example in FIGS. 1-2). The operations shown in process 700 may not be exhaustive and that other operations can be performed as well before, after, or in between any of the illustrated operations. Further, some of the operations may be performed simultaneously, or in a different order than shown in FIG. 7. In some implementations, some of the operations may be performed by a computer, or multiple computers. The one or more computers the process 700 will be described as being performed by a system of, located in one or more locations, and programmed appropriately in accordance with this specification. For example, one or more of a computation system 800 of FIG. 8, appropriately programmed, can perform the process 700.

At 702, a request for an issue stack is sent. The request can be based upon a trigger event (e.g., a new issue is experiences, or an issue of particular type is identified), and be to an issue repository storing issue reports for a multitude of software platforms, environments, applications, or combination thereof.

At 704, the issue stack is received from the issue repository. In some implementations, the issue stack is received, and the request is made based on a unique issue ID. In some implementations, the received issue stack includes metadata associated with the issue, such as frequency, timing, thread count, or other information.

At 706, a bot is identified to analyze the issue stack. The bot can be selected on the issue itself (e.g., based on the issue type, OS system, available compute resources, etc.).

At 708, the bot generates a prompt for a generative AI model. The prompt can include the call stack and one or more function calls based on previous prompts or training of the generative AI model. In general, the prompt requests an analysis of the call stack to be provided.

At 710, a result is received from the AI model, which can be formatted for consumption by the bot.

At 712, one or more of a search of a knowledge base or an internet search are performed based on the issue stack. The search may identify previously analyzed similar issues and resolutions, as well as trends of past error reports. In some implementations, cross-verification between the knowledge base and internet resources/search results are performed to improve the accuracy and relevance of proposed solutions. In some implementations, the knowledge base can be constructed or built, for example, based on solved online issue reports, developer documentation, and official guidance documents, and extract key technical points and issue resolution methods. In some implementations, the knowledge base is categorized by issue type (e.g., crash type), providing the system with abundant reference material for common issues.

At 714, an analysis result is generated. The analysis result can include one or more of the generative AI response and the knowledge base or internet search results. In general, the analysis result describes possible causes of the error, potential solutions and prevention methods, and provides other details to assist a developer in resolving the issue.

At 716, the analysis result can be sent to a user interface (e.g., GUI) for presentation. In some implementations, the analysis result is displayed in an analysis pane adjacent to a call stack that a developer is analyzing within the GUI.

At 718, the analysis result is stored. By storing the analysis result, future searches can benefit from it. Further the result can be curated and used for training or improving machine learning models including the bot and the generative AI in the future.

FIG. 8 illustrates a schematic diagram of an example computing system 800. The system 800 can be used for the operations described in association with the implementations described herein. For example, the system 800 may be included in computing devices of the one or more online components and/or the one or more offline components. The system 800 includes a processor 810, a memory 820, a storage device 830, and an input/output device 840, which are interconnected using a system bus 850. The processor 810 is capable of processing instructions for execution within the system 800. In some implementations, the processor 810 is a single-threaded processor. The processor 810 is a multi-threaded processor. The processor 810 is capable of processing instructions stored in the memory 820 or on the storage device 830 to display graphical information for a user interface on the input/output device 840.

The memory 820 stores information within the system 800. In some implementations, the memory 820 is a computer-readable medium. The memory 820 can be a volatile memory unit or a non-volatile memory unit. The storage device 830 is capable of providing mass storage for the system 800. The storage device 830 is a computer-readable medium. The storage device 830 may be a floppy disk device, a hard disk device, an optical disk device, or a tape device. The input/output device 840 provides input/output operations for the system 800. The input/output device 840 includes a keyboard and/or pointing device. The input/output device 840 includes a display unit for displaying graphical user interfaces.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship with each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations, but should be defined only in accordance with the following claims and their equivalents. Accordingly, other implementations also are within the scope of the claims.

What is claimed is:

1. A method comprising:
sending, from a developer portal system and to an issue repository, a request for an issue stack, wherein the issue stack is a report generated in response to a user experiencing a software issue;
receiving, from the issue repository and at the developer portal system, the issue stack;
sending, by the developer portal system, the issue stack and an issue ID to an analysis engine to be analyzed;
identifying, by the analysis engine, a bot to analyze the issue stack, wherein the identified bot comprises a first machine learning algorithm;
generating, by the bot, a prompt for a generative AI model, the prompt comprising the issue stack;
sending, by the analysis engine, the prompt to the generative AI model;
receiving a response from the generative AI model;
generating, by the bot, an analysis result based on the response from the generative AI model; and
sending the analysis result to the developer portal system for presentation at a user interface associated with the developer portal system.

2. The method of claim 1, wherein generating the analysis result comprises:
performing a search of a knowledge base for information associated with the issue stack; and
performing, by the bot, an internet search.

3. The method of claim 2, wherein the knowledge base comprises previously analyzed issue stacks and corresponding previous analysis results.

4. The method of claim 3, wherein the first machine learning algorithm is a neural network trained based on the previous analysis results, previously analyzed issue stacks, and manually analyzed issues.

5. The method of claim 1, wherein generating the analysis result comprises generating a text summary explaining a cause of the software issue.

6. The method of claim 1, wherein the bot is selected based on an operating system associated with the issue stack.

7. The method of claim 1, wherein sending the request for the issue stack is triggered in response to a selection of the issue in the user interface associated with the developer portal system.

8. The method of claim 1, comprising:
receiving a regeneration command at the analysis engine and in response:
re-sending the prompt to the generative model;
generating an updated analysis result; and
sending the updated analysis result to the developer portal system for presentation.

9. One or more computer-readable storage media storing one or more instructions that, when executable by one or more computers, cause the one or more computers to perform operations comprising:
sending, from a developer portal system and to an issue repository, a request for an issue stack, wherein the issue stack is a report generated in response to a user experiencing a software issue;
receiving, from the issue repository and at the developer portal system, the issue stack;
sending, by the developer portal system, the issue stack and an issue ID to an analysis engine to be analyzed;
identifying, by the analysis engine, a bot to analyze the issue stack, wherein the identified bot comprises a first machine learning algorithm;
generating, by the bot, a prompt for a generative AI model, the prompt comprising the issue stack;
sending, by the analysis engine, the prompt to the generative AI model;
receiving a response from the generative AI model;
generating, by the bot, an analysis result based on the response from the generative AI model; and
sending the analysis result to the developer portal system for presentation at a user interface associated with the developer portal system.

10. The computer-readable storage media of claim 9, wherein generating the analysis result comprises:
performing a search of a knowledge base for information associated with the issue stack; and
performing, by the bot, an internet search.

11. The computer-readable storage media of claim 10, wherein the knowledge base comprises previously analyzed issue stacks and corresponding previous analysis results.

12. The computer-readable storage media of claim 11, wherein the first machine learning algorithm is a neural network trained based on the previous analysis results, previously analyzed issue stacks, and manually analyzed issues.

13. The computer-readable storage media of claim 9, wherein generating the analysis result comprises generating a text summary explaining the cause of the software issue.

14. The computer-readable storage media of claim 9, wherein the bot is selected based on an operating system associated with the issue stack.

15. The computer-readable storage media of claim 9, wherein sending the request for the issue stack is triggered in response to a selection of the issue in the user interface associated with the developer portal system.

16. The computer-readable storage media of claim 9, the operations comprising:
receiving a regeneration command at the analysis engine and in response:
re-sending the prompt to the generative model;
generating an updated analysis result; and
sending the updated analysis result to the developer portal system for presentation.

17. A computer-implemented system, comprising:
one or more computers; and
one or more computer memory devices interoperably coupled with the one or more computers and having computer-readable storage media storing one or more instructions that, when executed by the one or more computers, perform one or more operations comprising:
sending, from a developer portal system and to an issue repository, a request for an issue stack, wherein the issue stack is a report generated in response to a user experiencing a software issue;
receiving, from the issue repository and at the developer portal system, the issue stack;
sending, by the developer portal system, the issue stack and an issue ID to an analysis engine to be analyzed;
identifying, by the analysis engine, a bot to analyze the issue stack, wherein the identified bot comprises a first machine learning algorithm;
generating, by the bot, a prompt for a generative AI model, the prompt comprising the issue stack;
sending, by the analysis engine, the prompt to the generative AI model;
receiving a response from the generative AI model;
generating, by the bot, an analysis result based on the response from the generative AI model; and
sending the analysis result to the developer portal system for presentation at a user interface associated with the developer portal system.

18. The system of claim 17, wherein generating the analysis result comprises:
performing a search of a knowledge base for information associated with the issue stack; and
performing, by the bot, an internet search.

19. The system of claim 18, wherein the knowledge base comprises previously analyzed issue stacks and corresponding previous analysis results.

20. The system of claim 19, wherein the first machine learning algorithm is a neural network trained based on the previous analysis results, previously analyzed issue stacks, and manually analyzed issues.
